(19) United States
(12) Patent Application Publication
(10) Pub. No.: US 2005/0175130 A1
(43) Pub. Date: Aug. 11, 2005

(54) CURRENT MODE IMAGE REJECTION MIXER AND METHOD THEREOF

(76) Inventor: Tony Yang, Irvine, CA (US)

Correspondence Address: NORTH AMERICA INTERNATIONAL PATENT OFFICE (NAIPC), P.O. BOX 506, MERRIFIELD, VA, 22116, US

(21) Appl. No.: 10/711,537

(22) Filed: Sep. 24, 2004

Related U.S. Application Data
(60) Provisional application No. 60/521,035, filed on Feb. 10, 2004.

(51) Int. Cl. H04B 1/10

(52) U.S. Cl. 375/350

(57) ABSTRACT

An image rejection mixer includes an in-phase mixer for mixing a received RF signal with an in-phase reference signal to produce a current mode in-phase mixed signal and a quadrature-phase mixer for mixing the received RF signal with a quadrature-phase reference signal to produce a current mode quadrature-phase mixed signal, the quadrature-phase reference signal and the in-phase reference signal having a substantially orthogonal phase difference. A polyphase filter network is coupled to the current mode outputs of the in-phase mixed signal and the current mode quadrature-phase mixed signal. An inductor is coupled between an output of the polyphase filter network and a supply voltage to convert an output of the image rejection mixer to a voltage mode signal.

### CROSS REFERENCE TO RELATED APPLICATIONS

This application claims the benefit of the filing date of U.S. provisional patent application No. 60/521,035, filed Feb. 10, 2004, and entitled “Image Rejection Mixer”, the contents of which are hereby incorporated by reference.

### BACKGROUND OF INVENTION

1. Field of the Invention

The invention relates to radio frequency communication, and more particularly, to image rejection mixers used in radio frequency (RF) communication systems.

2. Description of the Prior Art

FIG. 1 shows an example of information recovery in a radio frequency communication system from a received RF signal involving the generation and use of an intermediate frequency (IF) signal from the RF signal. The IF signal, whilst being at reduced frequency relative to the carrier signal, still has a relatively large frequency displacement with respect to baseband (dc). The problem with the use of such an intermediate frequency (IF) is that the signal at the relatively low IF can be very easily interfered with by an image signal I. More specifically, a wanted signal S sits above the local oscillator signal LO by an amount equal to the relatively low intermediate frequency IF, whilst the image signal I sits below the local oscillator signal LO by the same amount. On down mixing, the mixing combinations of |LO-S| and |LO-I| are both present at the intermediate frequency IF. Consequently, the image signal I interferes with the demodulation of the wanted signal S.

FIG. 2 shows a block diagram of a conventional differential image rejection mixer 200. Image rejection mixers achieve image-rejection through phase shifting operation. The conventional differential image rejection mixer 200 includes a local oscillator circuit 202, an in-phase mixer 204, a quadrature-phase mixer 206, a first and a second buffers 208, 210, and a polyphase filter network (PPF) 212. The local oscillator circuit 202 generates a differential in-phase reference signal (LO_I+, LO_I−) and a differential quadrature-phase reference signal (LO_Q+, LO_Q−), which have an orthogonal phase difference (i.e., the two reference signals differ in phase by 90 degrees), to drive the in-phase mixer 204 and the quadrature-phase mixer 206, respectively. The PPF 212 is cascaded through the first and second buffers 208, 210 to the in-phase and quadrature-phase mixers 204, 206, respectively. These circuit components constitute two mixing paths, and by joining the outputs of the two mixing paths, the unwanted component of the resulted IF signal (IF+, IF−) contributed by the image signal I can be effectively cancelled out whilst preserving the desired component of the IF signal contributed by the wanted RF signal S. The principle and architecture of image rejection technique are well-known to those of ordinary skill in the art and are further detailed in RF Microelectronics by B. Razavi, page 138-146, copyright 1998 Prentice Hall PTR, ISBN 0-13-887571-5, the contents of which are hereby incorporated by reference.

FIG. 3 shows a schematic diagram of the in-phase mixer 204. A similar circuit is also used to implement the quadrature-phase mixer 206. As shown in FIG. 3, the in-phase mixer 204 is implemented using a Gilbert mixer architecture and includes first and second inductors 302, 304 connected to the positive and negative sides of the differential in-phase mixed output signal (I_MIX+, I_MIX−), respectively.

However, the buffers 208, 210 in the conventional image-rejection mixer shown in FIG. 2, aiming to provide a low source impedance to drive PPF 212 and to maintain high linearity, consume large amounts of power and add mismatch between the in-phase and quadrature-phase paths. Additionally, the inductors 302 and 304 used on the differential output of the in-phase mixer 204 and the two inductors similarly required on the differential output of the quadrature-phase mixer 206 require a large amount of IC die area.

### SUMMARY OF INVENTION

One objective of the claimed invention is therefore to provide an image rejection mixer having reduced power consumption and reduced integrated circuit area.

According to an exemplary embodiment of the present invention, an image rejection mixer is disclosed, which comprises an in-phase mixer for mixing a received RF signal with an in-phase reference signal to produce a current mode in-phase mixed signal; a quadrature-phase mixer for mixing the received RF signal with a quadrature-phase reference signal to produce a current mode quadrature-phase mixed signal, the quadrature-phase reference signal and the in-phase reference signal having a substantially orthogonal phase difference; and a polyphase filter network having inputs receiving the current mode in-phase mixed signal and the current mode quadrature-phase mixed signal.

According to another exemplary embodiment of the present invention, a method of mixing a received RF signal with a reference signal and removing an image signal component is disclosed, which comprises mixing the received RF signal with an in-phase reference signal to produce a current mode in-phase mixed signal; mixing the received RF signal with a quadrature-phase reference signal to produce a current mode quadrature-phase mixed signal, the quadrature-phase reference signal and the in-phase reference signal having a substantially orthogonal phase difference; and providing a polyphase filter network to receive the current mode in-phase mixed signal and the current mode quadrature-phase mixed signal, so as to generate a resultant IF signal; wherein the image signal component is cancelled from the resultant IF signal.

According to yet another exemplary embodiment of the present invention, an image rejection mixer is disclosed, which comprises an in-phase mixer for mixing a received RF signal with an in-phase reference signal to produce an in-phase mixed signal at outputs of the in-phase mixer; a quadrature-phase mixer for mixing the received RF signal with a quadrature-phase reference signal to produce a quadrature-phase mixed signal at outputs of the quadrature-phase mixer, the quadrature-phase reference signal and the in-phase reference signal substantially having a substantially orthogonal phase difference; and a polyphase filter network having inputs receiving the in-phase mixed signal and the quadrature-phase mixed signal; wherein the outputs of the in-phase mixer and the outputs of the quadrature-phase mixer are cascoded to the polyphase filter network.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is an illustration of information recovery in a radio frequency communication system from a received RF signal involving the generation and use of an intermediate frequency signal from the RF signal.

FIG. 2 is a block diagram of a conventional differential image rejection mixer.

FIG. 3 is a schematic diagram of the in-phase mixer of FIG. 2.

FIG. 4 is a block diagram of an image rejection mixer 400 according to an embodiment of the present invention.

FIG. 5 shows a schematic diagram of the PPF of FIG. 4.

FIG. 6 shows a schematic diagram of the mixer unit of FIG. 4.

FIG. 7 shows a flowchart illustrating a method of mixing a received RF signal with a reference signal and removing an image signal according to an embodiment of the present invention.

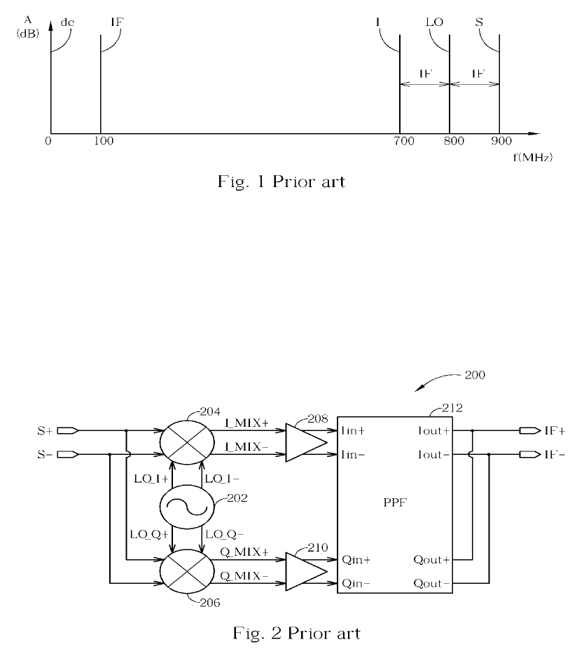

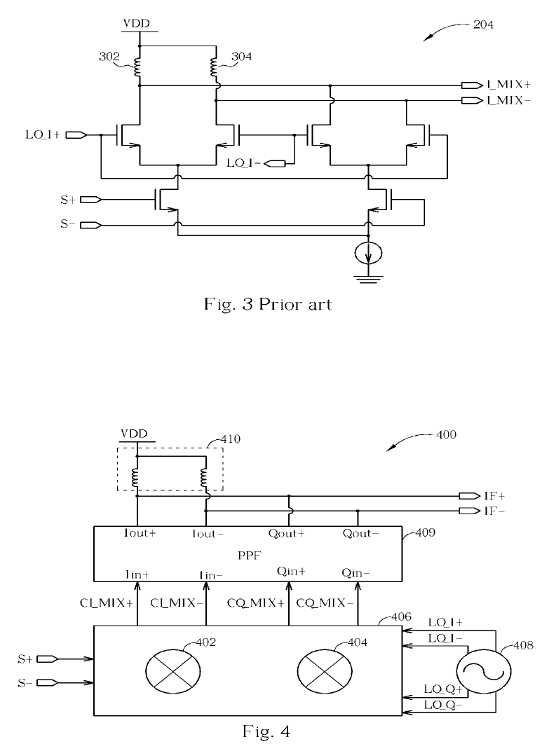

### DETAILED DESCRIPTION

It should be first noted that the image rejection mixers described in the embodiments of the present invention may be utilized in radio frequency receivers as well as transmitters, or any other electronic circuitries, systems, or subsystems that may require an image rejection mixing characteristic.

FIG. 4 is a block diagram of an image rejection mixer 400 according to an embodiment of the present invention. The image rejection mixer 400 includes a mixer unit 406, a local oscillator circuit 408, a polyphase filter (PPF) network 409, and a differential inductor 410. As shown in FIG. 4, the PPF 409 is cascaded to the mixer unit 406. In this embodiment, the mixer unit 406 further includes an in-phase mixer 402 and a quadrature-phase mixer 404. It should be noted that in another embodiment, the in-phase and quadrature-phase mixers 402, 404 can be implemented as separate mixers.

The received RF signal, differentially represented as S+, S−, is input to the mixer unit 406. The local oscillator circuit 408 generates a differential in-phase reference signal (LO_I+, LO_I−) and a differential quadrature-phase reference signal (LO_Q+, LO_Q−). As previously mentioned, the in-phase reference signal (LO_I+, LO_I−) and the quadrature-phase reference signal (LO_Q+, LO_Q−) have an orthogonal phase difference, which means the two reference signals differ in phase by 90 degrees. The in-phase reference signal (LO_I+, LO_I−) and the quadrature-phase reference signal (LO_Q+, LO_Q−) are input to the mixer unit 406. The mixer unit 406 mixes the received RF signal (S+, S−) with the in-phase reference signal (LO_I+, LO_I−) to produce a current mode in-phase mixed signal (CI_MIX+, CI_MIX−) and with the quadrature-phase reference signal (LO_Q+, LO_Q−) to produce a current mode quadrature-phase mixed signal (CQ_MIX+, CQ_MIX−). The current mode in-phase mixed signal (CI_MIX+, CI_MIX−) and the current mode quadrature-phase mixed signal (CQ_MIX+, CQ_MIX−) are injected into the PPF 409.

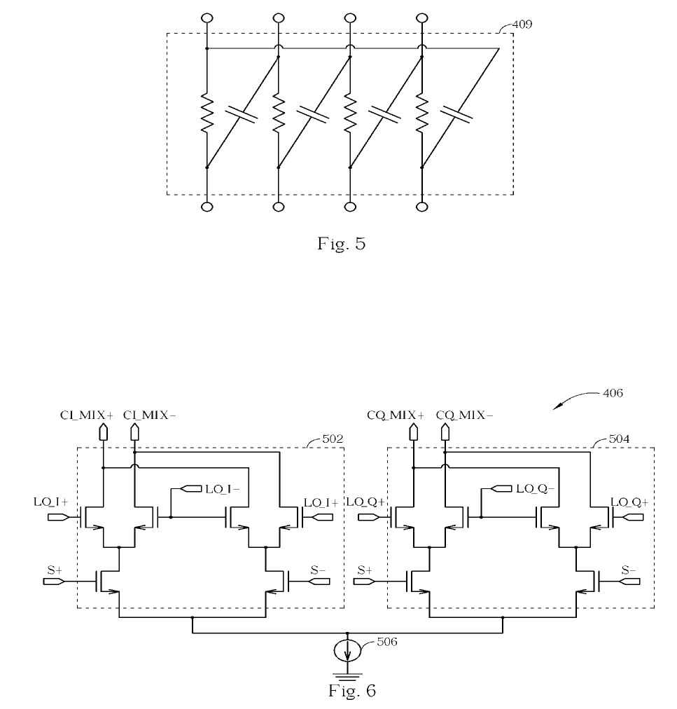

The PPF 409, as can be implemented in a known way shown in FIG. 5, accounts for the phase shifting operation as is well-known to those of ordinary skill in the art. The PPF 409 is so configured in a known way, as to properly match the frequency requirement of the image rejection mixer 400. The current mode in-phase and quadrature-phase signals outputted by the PPF 409 are added together (by joining the two paths) and a resultant IF signal, differentially represented as IF+ and IF−, is formed. As a result, the unwanted component of the resulted IF signal (IF+, IF−) contributed by the image signal I is effectively cancelled out whilst preserving the desired component of the IF signal contributed by the wanted RF signal S.

To allow current to flow through the cascoded mixer unit 406 and PPF 409, and to convert the differential IF output signal to a voltage mode signal, the differential inductor 410 is connected between the positive IF+ signal and the negative IF− signal and has a center tap connected to a power supply node VDD.

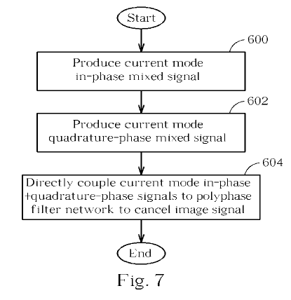

FIG. 6 shows a schematic diagram of the mixer unit 406. The mixer unit 406 includes a first Gilbert mixer 502 and a second Gilbert mixer 504 sharing a single current source 506. By sharing the single current source 506, the in-phase mixing operation performed by the first Gilbert mixer 502 is better matched with the quadrature-phase mixing operation performed by the second Gilbert mixer 504. Additionally, it should be pointed out that the differential output signals (CI_MIX+, CI_Mix−) and (CQ_MIX+, CQ_MIX−) of the mixer unit 406 are current mode signals. In other words, the outputs of the first Gilbert mixer 502 and the second Gilbert mixer 504 are open-drain connections, and these open-drain connections are connected in a cascode manner to the PPF 409. Finally, as shown in FIG. 4, the single differential inductor 410 coupled to the intermediate frequency output signal (IF+, IF−) allows current to flow through the PPF 409 and the mixer unit 406 and converts the intermediate frequency output signal (IF+, IF−) outputted by the PPF 409 to a voltage mode signal.

Please note that although the well-known Gilbert cells are adopted in the above-mentioned embodiment of the present invention to serve the mixing function, a skilled artisan in the pertinent art should be able to appreciate that, other mixer topologies, which provide mixing products as do the Gilbert cells, may be substituted in as building blocks of the present invention, and therefore fall within the metes and bounds of the claimed invention.

As shown in FIG. 4 and FIG. 6, the present invention image rejection mixer architecture does not require buffers and only requires a single differential inductor. As a result, circuit power and die size requirements of the image rejection mixer 400 are greatly reduced. Furthermore, potential mismatch between the in-phase and quadrature-phase paths caused by buffers can also be greatly alleviated, and a single-stage PPF, as shown in FIG. 5, can thus be used instead of a multi-stage PPF, which is conventionally adopted to account for such mismatch phenomenon. It should also be noted that a single-stage symmetrical PPF as disclosed by the same inventor in co-pending U.S. patent application Ser. No. 10/711,311 filed on Sep. 9, 2004, which is hereby incorporated by reference, can also be used in the stead of that shown in FIG. 5 with the present invention and will further reduce any mismatching between the in-phase and quadrature-phase paths. As such, the present invention image rejection mixer has a simplified circuit implementation, increased image signal rejection, reduced power requirements, and reduced integrated circuit (IC) die area.

FIG. 7 shows a flowchart illustrating a method of mixing a received RF signal with a reference signal and removing an image signal according to an embodiment of the present invention. The flowchart contains the following steps:

Step 600: Produce a current mode in-phase mixed signal by mixing the received RF signal with an in-phase reference signal.

Step 602: Produce a current mode quadrature-phase mixed signal by mixing the received RF signal with a quadrature-phase reference signal. As previously mentioned, the in-phase reference signal and a quadrature-phase reference signal have an orthogonal phase difference, which means the two reference signals differ in phase by 90 degrees.

Step 604: Directly couple the current mode in-phase and quadrature-phase signals to a polyphase filter network to cancel the image signal component from the resultant IF signal. The polyphase filter network is designed to account for a phase-shifting operation. By combining the in-phase and quadrature-phase output signals of the polyphase filter network, the image signal component is effectively cancelled out, leaving the desired RF signal intact in the resultant IF signal.

It should also be noted that although differential implementations using metal oxide semiconductor (MOS) transistors have been shown throughout the figures of the detailed description of the present invention, single ended implementations, bipolar junction transistor (BJT) implementations, and implementations utilizing other technologies are also fully supported by the present invention as will be obvious to a person of ordinary skill in the art of electronic design.

Those skilled in the art will readily observe that numerous modifications and alterations of the device and method may be made while retaining the teachings of the invention. Accordingly, the above disclosure should be construed as limited only by the metes and bounds of the appended claims.

1. An image rejection mixer comprising:
an in-phase mixer for mixing a received RF signal with an in-phase reference signal to produce a current mode in-phase mixed signal;
a quadrature-phase mixer for mixing the received RF signal with a quadrature-phase reference signal to produce a current mode quadrature-phase mixed signal, the quadrature-phase reference signal and the in-phase reference signal having a substantially orthogonal phase difference; and
a polyphase filter network having inputs receiving the current mode in-phase mixed signal and the current mode quadrature-phase mixed signal.

2. The image rejection mixer of claim 1, wherein the inputs of the polyphase filter network are directly connected to the outputs of the in-phase mixer and the quadrature-phase mixer.

3. The image rejection mixer of claim 1, further comprising an inductor coupled between an output of the polyphase filter network and a supply voltage to convert an output of the image rejection mixer to a voltage mode signal.

4. The image rejection mixer of claim 1, wherein the received RF signal, the in-phase reference signal, and the quadrature-phase reference signal are differential signals; the in-phase and quadrature-phase mixers are differential mixers; and the polyphase filter network has two differential inputs and one differential output.

5. The image rejection mixer of claim 4, further comprising a differential inductor coupled to the differential output of the polyphase filter network and having a center tap being coupled to a supply voltage to convert a differential output of the image rejection mixer to a differential voltage mode signal.

6. The image rejection mixer of claim 1, wherein the polyphase filter network is a single-stage polyphase filter network.

7. The image rejection mixer of claim 1, wherein the in-phase and quadrature-phase mixers are Gilbert mixers.

8. The image rejection mixer of claim 7, wherein the in-phase and quadrature-phase mixers are combined into one mixer unit having open drain outputs cascoded with the inputs of the polyphase filter network.

9. A method of mixing a received RF signal with a reference signal and removing an image signal component, the method comprising:
mixing the received RF signal with an in-phase reference signal to produce a current mode in-phase mixed signal;
mixing the received RF signal with a quadrature-phase reference signal to produce a current mode quadrature-phase mixed signal, the quadrature-phase reference signal and the in-phase reference signal having a substantially orthogonal phase difference; and
providing a polyphase filter network to receive the current mode in-phase mixed signal and the current mode quadrature-phase mixed signal, so as to generate a resultant IF signal;
wherein the image signal component is cancelled from the resultant IF signal.

10. The method of claim 9, wherein the inputs of the polyphase filter network are directly connected to the current mode in-phase mixed signal and the current mode quadrature-phase mixed signal.

11. The method of claim 9, further comprising converting an output signal of the polyphase filter network to a voltage mode signal using an inductor coupling the output signal of the polyphase filter network to a supply voltage.

12. The method of claim 9, wherein the received RF signal, the in-phase reference signal, the quadrature-phase reference signal, the in-phase mixed signal, and the quadrature-phase mixed signal are differential signals; and the polyphase filter network has two differential inputs and one differential output.

13. The method of claim 12, further comprising converting a differential output signal of the polyphase filter network to a differential voltage mode signal using a differential inductor coupled to the differential output of the polyphase filter network and having a center tap being coupled to a supply voltage.

14. The method of claim 9, wherein the polyphase filter network is a single-stage polyphase filter network.

15. The method of claim 9, further comprising:
providing an in-phase gilbert mixer used for mixing the received RF signal with the in-phase reference signal to produce the in-phase mixed signal; and
providing a quadrature-phase gilbert mixer used for mixing the received RF signal with the quadrature-phase reference signal to produce the quadrature-phase mixed signal.

16. The method of claim 15, wherein the in-phase and quadrature-phase gilbert mixers are combined into one mixer unit having open drain outputs cascoded with the inputs of the polyphase filter network.

17. An image rejection mixer comprising:
an in-phase mixer for mixing a received RF signal with an in-phase reference signal to produce an in-phase mixed signal at outputs of the in-phase mixer;
a quadrature-phase mixer for mixing the received RF signal with a quadrature-phase reference signal to produce a quadrature-phase mixed signal at outputs of the quadrature-phase mixer, the quadrature-phase reference signal and the in-phase reference signal substantially having a substantially orthogonal phase difference; and
a polyphase filter network having inputs receiving the in-phase mixed signal and the quadrature-phase mixed signal;
wherein the outputs of the in-phase mixer and the outputs of the quadrature-phase mixer are cascoded to the polyphase filter network.

18. The image rejection mixer of claim 17, wherein the inputs of the polyphase filter network are directly connected to the outputs of the in-phase mixer and the quadrature-phase mixer.
